(19) United States
(12) Patent Application Publication
(10) Pub. No.: US 2017/0305939 A1
(43) Pub. Date: Oct. 26, 2017

(54) METHOD FOR THE DIRECT SYNTHESIS OF METHYL CHLOROSILANES IN FLUIDIZED-BED REACTORS

(71) Applicant: Wacker Chemie AG, Munich (DE)

(72) Inventors: Javad MOHSSENI, Leipzig (DE); Jochen GROSS, Tuessling (DE); Konrad MAUTNER, Burghausen (DE); Natalia SOFINA, Burghausen (DE); Till WUESTENFELD, Riesa (DE)

(73) Assignee: Wacker Chemie AG, Munich (DE)

(21) Appl. No.: 15/515,612

(22) PCT Filed: Nov. 19, 2015
(86) PCT No.: PCT/EP2015/077096

§ 371 Date: Mar. 30, 2017

(30) Foreign Application Priority Data
Dec. 10, 2014 (DE) 10 2014 225 460.4

(51) Int. Cl. C07F 7/16; B01J 8/26

(52) U.S. Cl. CPC C07F 7/16; B01J 8/26; B01J 2208/00752

(57) ABSTRACT

Methylchlorosilanes are synthesized by an at least two stage reaction in which contact composition from a first fluidized bed reactor is fed to a second fluidized bed reactor.

### CROSS REFERENCE TO RELATED APPLICATIONS

This application is the U.S. National Phase of PCT Appln. No. PCT/EP2015/077096 filed Nov. 19, 2015, which claims priority to German Application No. 10 2014 225 460.4 filed Dec. 10, 2014, the disclosures of which are incorporated in their entirety by reference herein.

### BACKGROUND OF THE INVENTION

### 1. Field of the Invention

The invention relates to a process for the direct synthesis of methylchlorosilanes by reaction of chloromethane with a contact composition containing silicon, copper catalyst and promoter.

### 2. Description of the Related Art

In the Müller-Rochow direct synthesis, chloromethane is reacted with silicon in the presence of a copper catalyst and suitable promoters to form methylchlorosilanes, with not only a very high productivity (amount of silane formed per unit time and reaction volume) and a very high selectivity, based on the target product dimethyldichlorosilane, but also a very high silicon utilization combined with safe and at the same time flexible operation of the overall plant being demanded. Dimethyldichlorosilane is required, for example, for the preparation of linear polysiloxanes.

The direct synthesis can be carried out batchwise or continuously. The continuous direct synthesis is carried out in fluidized-bed reactors in which chloromethane is used simultaneously as a fluidizing medium and a reactant. The silicon required is milled beforehand to give a powder having a particle size of up to 700 μm and mixed with copper catalysts and promoters to form the contact composition; this is referred to as fresh contact composition (=contact composition 1). Contact composition 1 is subsequently introduced into the fluidized-bed reactor and reacted at a temperature in the range of 260-350° C. This forms an active contact composition (=contact composition 2), i.e. contact composition containing active sites. (Lewis and Rethwish, Catalyzed direct reaction of silicon, Stud. Org. Chem. 1993, 49, 107). Methylchlorosilanes are formed in an exothermic reaction at these active sites.

Unreacted chloromethane, the gaseous methylchlorosilanes and contact composition constituents leave the reactor. To ensure a high silicon utilization, these constituents can be recirculated in their entirety or in part back to the reactor. For example, the coarser part of the entrained contact composition particles can be separated off from the gas stream by means of one or more cyclones and optionally be recirculated via intermediate collection vessels back into the reactor. Since activated constituents of the contact composition are present here, these are a part of the contact composition 2.

The very finely particulate, entrained particles (=contact composition 3), which still comprise high proportions of copper and secondary elements in addition to silicon, likewise have to be separated off from the gas stream. This can, for example, be effected by gas filtration and/or one or more subsequent cyclones. This procedure with discharge of reacted particles can make a continuous process possible and ensure a high silicon utilization.

As an alternative, the entire entrained solids stream can be separated off and discharged from the system continually or only at particular intervals.

U.S. Pat. No. 4,281,149, FIG. 1, depicts by way of example such a system consisting of reactor, main cyclone with recirculation and after-cyclone with dust collection container. The crude silane is subsequently separated off from unreacted chloromethane and passed to a distillation. Purified, unreacted chloromethane can be fed back into the reactor.

The collected contact composition 3 has to be discharged since various secondary elements and proportions of slag which are introduced with the silicon have accumulated in this product stream, and if it were recirculated in its entirety into the reactor, the selectivity would be greatly reduced by catalytic effects of these impurities. Likewise, an accumulation of inert secondary elements which would reduce the on stream time of the reactor would occur. The ratio of contact composition 1 to contact composition 2 can vary greatly, in particular as a result of the above-described recirculation. Contact composition 2 is an active contact composition and already comprises a sufficient amount of copper and promoters. Contact composition 2 is able to react with chloromethane at relatively low temperatures and to produce silanes with high productivity and dimethyldichlorosilane selectivity. When contact composition 1 and contact composition 2 are mixed in the reactor, an unfavorable distribution of catalyst and promoters can occur since catalyst constituents also bind to activated particles and thus, for example, unnecessarily increase the consumption of catalyst or bring about an incorrect distribution of the active constituents.

To counter these disadvantages, the prior art discloses thermal pretreatment of the fresh contact composition. US 2003/0220514 describes a process in which silicon is thermally treated together with copper oxide and/or copper chloride at temperatures of 250-350° C. SiCl₄ is formed as by-product. This preactivated contact composition is mixed with unactivated silicon and used in the Müller-Rochow synthesis. This process makes it possible to produce concentrated contact compositions which are diluted with catalyst-free silicon before the alkylhalosilane synthesis. U.S. Pat. No. 6,528,674B1 describes a 2-stage process in which silicon is treated with a copper compound at a temperature below 500° C. In a second step, this pretreated contact composition is after-treated under inert gas at temperatures above 500° C. This contact composition which has been treated thusly is used in the Müller-Rochow synthesis for the production of dimethyldichlorosilane. WO 99/64429 describes a process for preparing alkylhalosilanes by reaction of a thermally pretreated contact composition with alkyl halide. The pretreatment comprises a reaction of silicon together with catalysts and promoters with carbon monoxide at temperatures in the range from 270 to 370° C., which results in an increase in the production rate.

DE102011006869 A1 describes a process in which silicon, copper compound, copper metal, zinc, zinc compound, tin, or tin compound, where at least the copper catalyst or promoter contains a chloride, are mixed to give a contact composition and the mixture is heated at a temperature in the range from 200° C. to 600° C. under a stream of carrier gas selected from among N₂, noble gases, CO₂, CO and H₂, and used for the preparation methylchlorosilane.

The activation of the contact composition by means of a prereactor using HCl before the reaction with chloromethane is known, for example, from U.S. Pat. No. 4,864,044. There, a process in which silicon, copper catalyst, and optionally tin promoters but no zinc promoters, can be activated by means of HCl at about 325° C. is described in the examples. The disadvantages of this form of activation are that zinc or zinc compounds can be added only after the activation, since zinc reacts with HCl under the reaction conditions indicated to form readily sublimable zinc chloride and can thus be removed from the contact composition during the activation, and a dedicated reactor is necessary for the activation and the reaction products of the activation. In particular, trichlorosilane and tetrachlorosilane represent undesirable by-products of the methylchlorosilane synthesis. At least 1 to 2% of the silicon raw material used is consumed by the activation, and a relatively high activation temperature is required.

DE 19817775A1, too, states that fresh contact composition is not active enough. It should, for example, be activated by means of HCl.

There are further disadvantages of a separate pretreatment of the fresh contact composition. Fresh contact composition has to be heated to 370° C. for a certain time. This leads to high operational costs and capital costs. Steam is normally the heat source in industrial operations. A temperature of 300° C. can only be achieved using steam under extreme pressure, which is available in very few operations. Silanes, in particular chlorosilanes, are formed from CuCl and silicon during the preactivation and these have to be discharged and treated.

U.S. Pat. No. 2,389,931 describes reactor cascades (fluidized-bed reactors) in which greatly reacted contact composition from a reactor is separated off, cooled and introduced into a second reactor. This makes the silicon utilization more effective but very much more methyltrichlorosilane is formed as a result of the drastic reaction conditions. The contact composition also loses reactivity and selectivity due to the cooling.

### SUMMARY OF THE INVENTION

The present invention provides a process for preparing methylchlorosilanes by reaction of chloromethane with a contact composition, wherein a mixture containing silicon, copper catalyst and promoter (contact composition 1) is fed into a first fluidized-bed reactor (fluidized-bed reactor 1), active contact composition (contact composition 2) is formed in the presence of chloromethane at from 200 to 450° C., part of the contact composition 2 is taken off from the fluidized-bed reactor 1, preferably via cyclones of the fluidized-bed reactor 1 preferably by means of reaction gas, preferably chloromethane, and fed into a second fluidized-bed reactor (fluidized-bed reactor 2) and reacted with chloromethane at from 200 to 450° C., where at least 20 parts by weight of contact composition 2 per 100 parts by weight of contact composition 1 are recirculated per unit time into fluidized-bed reactor 1 and the contact composition 2 which has been fed into the fluidized-bed reactor 2 and recirculated into fluidized-bed reactor 1 is not cooled below a temperature of 150° C. after being taken off from the fluidized-bed reactor 1.

### DETAILED DESCRIPTION OF THE PREFERRED EMBODIMENTS

The contact composition 2 is significantly more active than a fresh contact composition (contact composition 1) and than a preactivated contact composition which has been activated under N₂ at, for example, about 300° C. The reaction of chloromethane with activated Si particles liberates energy. This leads to local temperature increases of up to several 100° C., and the surface is also freed of oxide layers and further passivating layers.

No separate apparatus has to be provided for the production of contact composition 2. It is possible to use the existing fluidized-bed reactors.

The fluidized-bed reactors 1 and 2 can be operated using different parameters such as pressure and temperature and thereby be adapted to the differences between the contact compositions 1 and 2 with different properties. Completely reacted contact composition is preferably discharged via a cyclone arranged downstream of the fluidized-bed reactor 2.

In a particular embodiment, the contact composition constituents (contact composition 3) discharged from the fluidized-bed reactor 2 or from the fluidized-bed reactors 1 and 2 with the gas stream is completely or partly recirculated into the fluidized-bed reactor 2. The contact composition 3 is preferably separated off from the gas stream using one or more cyclones.

The fluidized-bed reactor 1 is preferably operated at a higher temperature than the fluidized-bed reactor 2. Preference is given to the fluidized-bed reactor 1 being operated at 300-350° C. and fluidized-bed reactor 2 being operated at 250-300° C., with the temperature in the fluidized-bed reactor 1 preferably being higher. As a result, the fluidized-bed reactor 1 becomes more active and the fluidized-bed reactor 2 becomes more selective. This leads to overall better performances of the fluidized-bed reactors with greater selectivity with respect to dimethyldichlorosilane.

In a particular embodiment, further catalysts and/or promoters are added to the contact composition 2 taken off from the fluidized-bed reactor 1.

From 1 to 80% by weight, more preferably from 10 to 50% by weight, of the contact composition 1 fed into the fluidized-bed reactor 1 are preferably taken off per unit time from the fluidized-bed reactor 1 as contact composition 2 and fed into the fluidized-bed reactor 2.

In a particular embodiment, a plurality of, in particular, from 2 to 5, fluidized-bed reactors 1 are used. From 1 to 50% by weight, more preferably from 5 to 20% by weight, of the contact composition 1 fed in is preferably taken off as contact composition 2 from each of these fluidized-bed reactors 1 and fed into the fluidized-bed reactor 2.

From 30 to 50 parts by weight of contact composition 2 per 100 parts by weight of contact composition 1 are preferably recirculated per unit time into fluidized-bed reactor 1.

In a particular embodiment, the contact composition 2 taken off from one or more fluidized-bed reactors 1 is collected in a collection vessel and fed from the collection vessel into one or more fluidized-bed reactors 2.

In a particular embodiment, a plurality of, in particular from 2 to 5, fluidized-bed reactors 2 are used.

In a particular embodiment, the contact composition 2 is mixed with a thermally conductive material before it is fed into the fluidized-bed reactor 2. This improves the heat transfer of the contact composition particles (hot spots) at a heat removal system, for example a cooling finger.

The thermally conductive material is preferably selected from among silicon, silicon carbide or silicon dioxide, having a preferred particle size of 100-800 microns, more preferably 200-400 microns. Preference is given to mixing 100 parts by weight of contact composition 2 with up to 40 parts by weight, in particular with up to 20 parts by weight, of thermally conductive material.

The contact composition 2 fed into the fluidized-bed reactor 2 is preferably not cooled below a temperature of 180° C., in particular not below 200° C., after being taken off from the fluidized-bed reactor 1.

The contact composition 2 is preferably taken off from the fluidized-bed reactor 1 by means of reaction gas, preferably chloromethane. The contact composition 2 and optionally also the contact composition 3 is preferably fed into the fluidized-bed reactor 2 in a form which has been fluidized by means of chloromethane.

The silicon used in the process preferably contains not more than 5% by weight, more preferably not more than 2% by weight, and in particular not more than 1% by weight, of other elements as impurities. The impurities, which make up at least 0.01% by weight, are preferably elements selected from among Fe, Ni, Mn, Al, Ca, Cu, Zn, Sn, C, V, Ti, Cr, B, P, and O.

The particle size of the silicon is preferably at least 0.5 microns, more preferably at least 5 microns, and in particular at least 10 microns, and preferably not more than 650 microns, more preferably not more than 580 microns, and in particular not more than 500 microns.

The average particle size distribution of the silicon is the d50 value and is preferably at least 180 microns, more preferably at least 200 microns, and in particular at least 230 microns, and preferably not more than 350 microns, more preferably not more than 300 microns, and in particular not more than 270 microns.

The copper for the catalyst can be selected from among metallic copper, a copper alloy and a copper compound. The copper compound is preferably selected from among copper oxide and copper chloride, in particular CuO, Cu₂O, and CuCl, and a copper-phosphorus compound (CuP alloy). Copper oxide can be, for example, copper in the form of copper oxide mixtures and in the form of copper(II) oxide. Copper chloride can be used in the form of CuCl or in the form of CuCl₂, with corresponding mixtures also being possible. In a preferred embodiment, the copper is used as CuCl.

Preference is given to using at least 0.1 parts by weight, more preferably at least 1 part by weight, of copper catalyst and preferably not more than 10 parts by weight, in particular not more than 8 parts by weight, of copper catalyst, in each case based on metallic copper, per 100 parts by weight of silicon.

The contact composition 1 preferably contains a zinc promoter which is preferably selected from among zinc and zinc chloride. Preference is given to using at least 0.01 parts by weight of zinc promoter, more preferably at least 0.1 parts by weight of zinc promoter, and preferably not more than 1 part by weight, in particular not more than 0.5 parts by weight, of zinc promoter, in each case based on metallic zinc, per 100 parts by weight of silicon.

The contact composition 1 preferably contains a tin promoter which is preferably selected from among tin and tin chloride. Preference is given to using at least 0.001 parts by weight of tin promoter, more preferably at least 0.05 parts by weight of tin promoter, and preferably not more than 0.2 parts by weight, in particular not more than 0.1 parts by weight, of tin promoter, in each case based on metallic tin, per 100 parts by weight of silicon.

The contact composition 1 preferably contains a combination of zinc promoter and tin promoter, and in particular additionally contains a phosphorus promoter.

Preference is given to at least 30% by weight, in particular at least 50% by weight, of the total of copper catalyst and promoters being chlorides of copper, zinc and tin.

Apart from the zinc and/or tin promoters, it is also possible to use further promoters which are preferably selected from among the elements phosphorus, cesium, barium, manganese, iron and antimony and compounds thereof.

The P promoter is preferably selected from among CuP alloys.

The pressure in the reaction is preferably at least 1 bar, in particular at least 1.5 bar, and preferably not more than 5 bar, in particular not more than 3 bar, in each case reported as absolute pressure.

The methylchlorosilanes prepared are, in particular, dimethyldichlorosilane, methyltrichlorosilane, trimethylchlorosilane and H-silanes.

The process can be carried out batchwise or preferably continuously. Continuously means that silicon which has reacted and possibly catalysts and promoters discharged with the reaction dust are continually replaced, preferably as premixed contact composition 1 and contact composition 2 and optionally contact composition 3. Preference is given to chloromethane being simultaneously introduced as a reactant and fluidizing medium into the fluidized-bed reactors 1 and 2.

In the following examples, all amounts and percentages are, unless indicated otherwise in the particular case, by weight, all pressures are 0.10 MPa (abs.) and all temperatures are 20° C.

### EXAMPLES

I) Examination of the Performance of Contact Composition 2:
1. 50 g of contact composition 2 from an industrial fluidized-bed reactor are reacted with about 20 l/h of chloromethane at 340° C. in a laboratory fluidized-bed reactor. After a reaction time of 7 hours, 103 g of crude silane had been obtained with a dimethyldichlorosilane selectivity of 71% (73 g of dimethyldichlorosilane).
2. 280 ppm of P were added to 50 g of contact composition 2 from an industrial fluidized-bed reactor and reacted with about 20 l/h of chloromethane at 340° C. in a laboratory fluidized-bed reactor. After a reaction time of 7 hours, 93 g of crude silane had been obtained with a dimethyldichlorosilane selectivity of 78% (73 g of dimethyldichlorosilane). The addition of P to contact composition 2 leads to a lower activity but an increase in the selectivity, so that ultimately the same amount of dimethyldichlorosilane is produced with a significantly smaller amount of secondary silanes.
3. 50 g of contact composition 2 from an industrial fluidized-bed reactor were reacted with about 20 l/h of chloromethane at 320° C. in a laboratory fluidized-bed reactor. After a reaction time of 7 hours, 86 g of crude silane had been obtained with a dimethyldichlorosilane selectivity of 74% (64 g of dimethyldichlorosilane). The temperature decrease does lead to a lower activity but to better selectivity.

### II) Examination of the Performance of 50% of Contact Composition 2+50% of Contact Composition 1:

25 g of contact composition 2 from an industrial fluidized-bed reactor together with 25 g of contact composition 1 were reacted with about 20 l/h of chloromethane at 340° C. in a laboratory fluidized-bed reactor. After a reaction time of 7 hours, 33 g of crude silane had been obtained with a dimethyldichlorosilane selectivity of 76% (25 g of dimethyldichlorosilane).
The addition of contact composition 1 leads to a significantly lower activity.

1.-9. (canceled)

10. A process for preparing methylchlorosilanes by reaction of chloromethane with a contact composition, comprising:
feeding a mixture containing silicon, copper catalyst and promoter (contact composition 1) into a first fluidized-bed reactor, wherein an active contact composition (contact composition 2) is formed in the presence of chloromethane at from 200 to 450° C., taking off a portion of the contact composition 2 from the first fluidized-bed reactor and feeding this portion into a second fluidized-bed reactor and reacting with chloromethane at from 200 to 450° C., where at least 20 parts by weight of contact composition 2 per 100 parts by weight of contact composition 1 are recirculated per unit time from the second fluidized reactor into the first fluidized-bed reactor, and contact composition 2 which has been fed into the second fluidized-bed reactor and recirculated into the first fluidized-bed reactor is not cooled below a temperature of 150° C. after being taken off from the first fluidized-bed reactor.

11. The process of claim 10, wherein contact composition constituents discharged from the second fluidized-bed reactor or from the first and second fluidized-bed reactors with a gas stream (contact composition 3) are completely or partly recirculated into the second fluidized-bed reactor.

12. The process of claim 10, wherein the first fluidized-bed reactor is operated at a higher temperature than the second fluidized-bed reactor.

13. The process of claim 11, wherein the first fluidized-bed reactor is operated at a higher temperature than the second fluidized-bed reactor.

14. The process of claim 10, wherein a plurality of first fluidized-bed reactors are employed.)

15. The process of claim 11, wherein a plurality of first fluidized-bed reactors are employed.)

16. The process of claim 12, wherein a plurality of first fluidized-bed reactors are employed.

17. The process of claim 10, wherein a plurality of second fluidized-bed reactors are employed.

18. The process of claim 11, wherein a plurality of second fluidized-bed reactors are employed.

19. The process of claim 12, wherein a plurality of second fluidized-bed reactors are employed.

20. The process of claim 14, wherein a plurality of second fluidized-bed reactors are employed.

21. The process of claim 10, wherein the silicon contains not more than 2% by weight of other elements as impurities.

22. The process of claim 10, wherein the contact composition contains a zinc promoter.

23. The process of claim 10, wherein the contact composition contains a tin promoter.

24. The process of claim 10, wherein the copper catalyst comprising copper oxide, copper chloride, or a copper-phosphorus compound.
